(19) United States
(12) Patent Application Publication
(10) Pub. No.: US 2002/0132646 A1
(43) Pub. Date: Sep. 19, 2002

(54) Hands-free filtering system for radiotelephones

(76) Inventor: Raoul Girod, Brignais (FR)

Correspondence Address: Oliff & Berridge, PO Box 19928, Alexandria, VA, 22320, US

(21) Appl. No.: 09/980,334

(22) PCT Filed: Apr. 3, 2001
(86) PCT No.: PCT/FRO1/01001

(30) Foreign Application Priority Data
Apr. 3, 2000 (FR) 00.04218

(51) Int. Cl. H04B 1/06

(52) U.S. Cl. 455/569; 455/345

(57) ABSTRACT

The invention concerns a hands-free apparatus enabling at vehicle driver to telephone but preventing him from using his hand-held radiotelephone if the vehicle is running.

The present invention defines a system for using a radiotelephone in a vehicle that compels a driver to use a hands-free system.

The use of a hand-held radiotelephone while driving a vehicle is dangerous and prohibited by the highway code in many countries. Hands-free systems exist, but do not prevent a driver from using a hand-held telephone while driving. The same remarks apply to similar cases such as the operation of machinery or other equipment capable of use by a human being.

Thus, the goal of the present invention is to:

prevent the use of a hand-held telephone by a driver;

enable a driver, as well as other vehicle occupants, to use hands-free systems, or telephones, if the driver has turned off a scrambler by hanging up the telephone; and

enabling all options if the vehicle is stopped or the contact is turned off.

The prior art includes hands-free systems as well as radiotelephone scrambler or filtering systems, but a combination of the two does not exist. Thus, for scrambling or filtering radiotelephones, the following patents relate to systems hereinafter called “scrambler filter” systems:

FR2764144: apparatus for filtering radiotelephones

FR2764145: apparatus for filtering radiotelephones

FR2765753: devices for managing filtering

WO9901958 and WO9856130 (corresponding documents).

The present invention defines the architecture of a hands-free system that, when combined with a scrambler filter, prevents the hand-held use of a radiotelephone, while enabling a hands-free system to be used, when the vehicle is in motion. Further, the invention permits either mode—hands-free or hand-held—of a radiotelephone, for example, to occur when the electrical contact of the vehicle is disconnected.

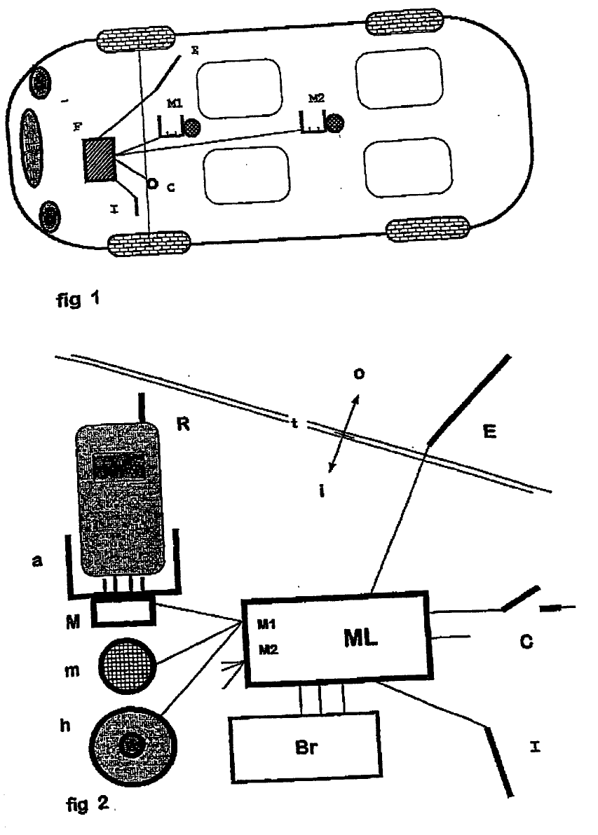

FIG. 1 shows the installation of the invention in a vehicle.

F represents the central housing of the hands-free system associated with a radiotelephone scrambler filter, whether these are separate or grouped together.

I is the internal antenna that transmits and receives the signals inside the vehicle. The internal antenna represents the active scrambler filter element that prevents hand-held communications inside the vehicle.

E is the external antenna of the vehicle. The external antenna is isolated from the transmissions of internal antenna I by the hood of the vehicle. The external antenna enables the hands-free system to connect with the radiotelephone system stations for operation of the hands-free system, and enables the information necessary for operation of the scrambler filter to be sent.

C represents the electrical contact of the vehicle, which powers the vehicle and enables the scrambler filter to be activated when the vehicle is in motion. To deactivate the scrambler filter from inside the vehicle, the vehicle must be turned off.

M1 and M2 represents the sockets the radiotelephones must be plugged into in order to operate, for the front and rear seats. One possible variant enables the passengers to use their telephones. Hanging up the driver's telephone prevents the scrambler from operating.

FIG. 2 shows the housing ML, which is the central unit of the filtering hands-free system subject of the present invention.

The roof of the vehicle is represented by t, which separates space i from outside space o.

Br represents a radiotelephone scrambler filter. This radiotelephone scrambler filter Br may be of several types such as those in the patents listed at the beginning of the present description or otherwise available on the market.

A microphone is represented by m and a speaker of the hands-free system is represented by h.

M represents the base for receiving radiotelephone support a. M is standard in the vehicle while a depends on the radiotelephone model and can be easily replaced.

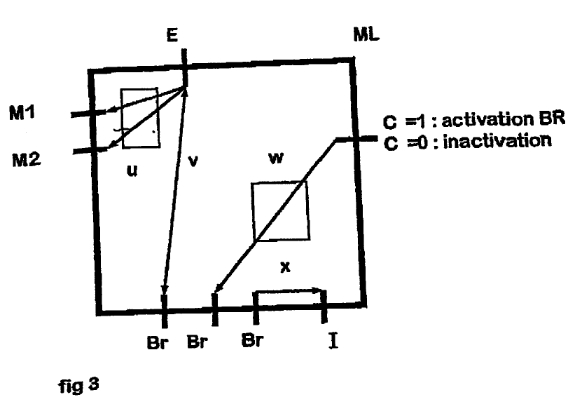

FIG. 3 shows the functions and links provided by the central unit of the filtering hands-free system of the present invention.

The link between the outside antenna and the components distributed inside the vehicle for the hands-free system is represented as u. This link may include an amplification module. This function also provides a link between the following components: microphones, speakers, and radiotelephone R.

The link between the outside antenna and the scrambler filter is represented as v.

The link between the vehicle electrical contact (contact key) and the scrambler filter is represented as w. Either the scrambler filter is powered, hence turned on, by this electrical link, or it is controlled by the existence of a voltage at this link w.

The transfer between the scrambler filter and the scrambling antenna inside the vehicle is represented by x.

In one variant, this link may be nonexistent in the case that the scrambler filter is connected directly to the inside antenna.

In certain variants of this invention, the scrambler filter can be built into a single housing, combining it with the central unit of the hands-free system.

This system can be used in all vehicles, equipment or machinery driven, guided, or operated by a human being.

Services responsible for enforcing laws, by activating the electrical contact, can check the existence of a scrambler filter by noting whether radiotelephones have been inactivated inside the stopped vehicle.

1. Hands-free radiotelephone apparatus enabling hands-free utilization but preventing utilization of the hand-held radiotelephone when the vehicle or the equipment is active or in motion, characterized in that it provides the link and connection between the hands-free system and a radiotelephone scrambler filter located inside the vehicle and activated when the vehicle is started.

2. Apparatus according to claim 1, characterized in that it connects an outside antenna to the hands-free system and to the scrambler filter system simultaneously.

3. Apparatus according to claim 1 and 2, characterized in that it uses a base receiving a support for the radiotelephone, the support being a function of the radiotelephone model and being replaceable.

4. Apparatus according to claims 1 and 2 characterized in that it provides the connection to the hands-free system for the other passengers.

5. Apparatus according to claim 1, characterized in that insertion of the driver's telephone into the base of the hands-free apparatus cuts off transmission from the scrambler.

6. Apparatus according to claims 1 and 2, characterized in that it includes a link between the electrical contact of the vehicle and the scrambler filter, the scrambler filter being either powered and activated by this electrical link, or controlled by the existence of a voltage at this link.
